(19) United States
(12) Patent Application Publication
(10) Pub. No.: US 2012/0112726 A1
(43) Pub. Date: May 10, 2012

(54) POWER SUPPLY CONTROLLER

(76) Inventors: Hiroki Kaihori, Osaka (JP); Michiaki Tsuneoka, Osaka (JP); Eiji Miyake, kyoto (JP)

(21) Appl. No.: 13/383,221

(22) PCT Filed: Sep. 1, 2010
(86) PCT No.: PCT/JP2010/005369

§ 371 Date: Jan. 10, 2012

(30) Foreign Application Priority Data
Sep. 9, 2009 (JP) 2009-207701

(51) Int. Cl. G05F 5/00

(52) U.S. Cl. 323/299

(57) ABSTRACT

A power supply controller includes a power supply section, a power supply controlling section connected to the power supply section, a starter switch being switched selectively to a first status and a second status, a o power switch being switched selectively to a first status and a second status, a controlling section connected to the power switch, and a function section operable to execute a predetermined operation. The power supply controlling section causes a power to be supplied from the power supply section to the controlling section when at least one of the power switch and the starter switch is in the first status. This power supply controller does not malfunction even when the starter switch malfunctions, thus preventing wasteful consumption of the power supply section.

### TECHNICAL FIELD

The present invention relates to a power supply controller used for, e.g. a small sensor unit for detecting biological information of a human body or animal.

### BACKGROUND ART

FIG. 5 is a block diagram of apparatus 501 disclosed in Patent Literature 1. Apparatus 501 includes conventional power supply controller 126 and detects human body biological information. Apparatus 501 is a capsule endoscope energized by a battery. Power supply controller 126 includes reed switch 102A, flip-flops 126B and 126C constituting a latch circuit, and field-effect transistors (FETs) 126D and 126E that are connected to flip-flops 126B and 126C and that function as switch elements. One end of reed switch 102A is grounded and the other end thereof is connected to the latch circuit to function as a power switch that is turned on and off depending on a magnetic field applied from outside. When flip-flops 126B and 126C receive a clock generated due to the turning on and off of reed switch 102A, flip-flops 126B and 126C sequentially turn on FETs 126D and 126E.

Specifically, upon receiving the magnetic field from the outside, reed switch 102A is turned on and the signal level at point Pa changes from a high (H) level to a low (L) level. Upon receiving no magnetic field, reed switch 102A is turned off and changes the signal level at point Pa from the L level to the H level. This operation inputs a clock to a CK terminal of flip-flop 126B. Flip-flop 126B outputs, from Q terminal, a signal (point Pb) obtained by frequency-dividing the rising edge from L level to H level at point Pa. FET 126D is turned on when the level of the signal output from Q terminal of flip-flop 126B is an L level. Then, power is supplied from battery 129 to light emitting diode (LED) driving circuit 121 and CCD driving circuit 123 to start LED driving circuit 121 and CCD driving circuit 123, thereby driving LED 120 to light LED 120.

Next, upon receiving a magnetic field from the outside, the signal at point Pa again changes from H level to L level. By this operation, the level of the signal at point Pb output from Q terminal of flip-flop 126B changes to H level. Then, FET 126D is turned off to stop the power supply to the entire circuit, thus turning off LED 120. Upon receiving a magnetic field from the outside again, the level of the signal at point Pa again changes from an H level to an L level. This operation changes the level of the signal output from Q terminal of flip-flop 126B to an L level (point Pb). Then, FET 126D is turned on to supply power from battery 129 to LED driving circuit 121 and CCD driving circuit 123, thereby lighting LED 120. As described above, by applying a magnetic field to reed switch 102A, FET 126D is turned on by a so-called toggle operation.

The signal output from Q terminal of flip-flop 126B is input to the clock terminal of flip-flop 126C having a function to start RF transmitter unit 124 only. Flip-flop 126C outputs, from Q terminal, a signal obtained by frequency-dividing the rising edge of the signal at point Pb at which the signal changes from L level to H level. Thus, FET 126E is turned on upon reed switch 102A being turned on by the second application of a magnetic field, and is turned off upon reed switch 102A being turned on by the fourth application of a magnetic field. Thus, the third application of a magnetic field turns on FETs 126D and 126E, thus also supplying the power from battery 129 to RF transmitter unit 124. Apparatus 501 is preferably set, at the shipment from the plant for example, to the above first magnetic field-applied status and is subjected, when being used to an object, to the third application of a magnetic field so that all of LED 120, CCD 122, and RF transmitter unit 124 can be driven.

In conventional apparatus 501, when reed switch 102A malfunctions due to, e.g. an external impact, the statuses of FETs 126D and 126E may change unexpectedly, thus resulting in wasteful consumption of battery 129.

### Citation List

Patent Literature
Patent Literature 1: Japanese Patent Laid-Open Publication No.2006-223473

### SUMMARY OF THE INVENTION

A power supply controller includes a power supply section, a power supply controlling section connected to the power supply section, a starter switch being switched selectively to a first status and a second status, a power switch being switched selectively to a first status and a second status, a controlling section connected to the power switch, and a function section operable to execute a predetermined operation. The power supply controlling section causes a power to be supplied from the power supply section to the controlling section when at least one of the power switch and the starter switch is in the first status.

This power supply controller does not malfunction even when the starter switch malfunctions, thus preventing wasteful consumption of the power supply section.

### BRIEF DESCRIPTION OF THE DRAWINGS

FIG. 1 is a block diagram of a power supply controller according to Exemplary Embodiment 1 of the present invention.

FIG. 2 is a block diagram of a power supply controller according to Exemplary Embodiment 2 of the invention.

FIG. 3A is a block diagram of a power supply controller according to Exemplary Embodiment 3 of the present invention.

FIG. 3B is a block diagram of another power supply controller according to Embodiment 3.

FIG. 4 is a block diagram of a power supply controller according to Exemplary Embodiment 4 of the present invention.

FIG. 5 is a block diagram of a conventional power supply controller.

### DETAIL DESCRIPTION OF PREFERRED EMBODIMENTS

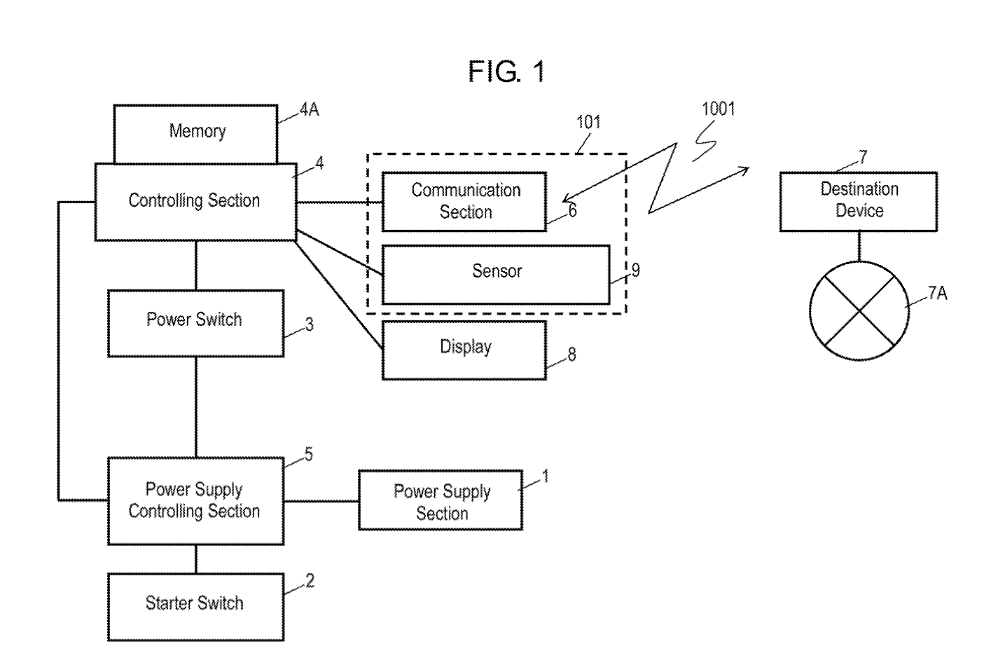

FIG. 1 is a block diagram of power supply controller 1001 according to Exemplary Embodiment 1 of the present invention. Power supply controller 1001 includes power supply section 1, power supply controlling section 5 connected to power supply section 1, starter switch 2 connected to power supply controlling section 5, power switch 3 connected to power supply controlling section 5, controlling section 4 connected to power switch 3, and function section 101 for executing a predetermined operation. Power supply controlling section 5 is also connected to controlling section 4. Function section 101 includes communication section 6 connected to controlling section 4.

Power supply section 1 supplies power to controlling section 4 via power supply controlling section 5 to drive controlling section, and is implemented by, e.g. a commercial power supply or a battery.

Starter switch 2 functions as a trigger to firstly supply a power from power supply section 1 to power supply controlling section 5. Starter switch 2 may be, for example, a switch button actuated by a user, a reed switch operating in a special magnetic field, or a noncontact switch, such as a transistor, performing a switching operation or a contact switch, such as a relay.

Power switch 3 is turned on and off by controlling section 4, and is implemented by, e.g. a transistor performing a switching operation.

Controlling section 4 is implemented by, e.g. a one-chip microcomputer. Controlling section 4 may include a ROM storing a program for operating power supply controller 1001, a RAM used to execute the program, a memory, such as a flash memory, and a CPU providing a control based on the program.

Power supply controlling section 5 is a switch that supplies power from power supply section 1 to controlling section 4 upon starter switch 2 or power switch 3 is turned on, and is implemented by, e.g. a transistor performing a switching operation.

Communication section 6 is controlled by controlling section 4. Communication section 6 may be a wired communication device, such as USB or IEEE1394, or a wireless device, such as a wireless LAN or Bluetooth™.

Destination device 7 is a communication device that can communicate with communication section 6. Destination device 7 may be a device including a wired device, such as USB or IEEE1394, or a wireless device, such as a wireless LAN or Bluetooth™.

Display 8 is a device that displays the status of power supply controller 1001, and may be implemented by, e.g. an LED or a liquid crystal display monitor.

Function section 101 further includes sensor 9 connected to controlling section 4. Sensor 9 may be any of various sensors including a thermal sensor, a contact-type temperature sensor, a noncontact-type temperature sensor, an optical sensor, a magnetic sensor, an audio sensor, a concentration sensor, such as an ion concentration sensor or a gas concentration sensor, a displacement sensor, a rotation sensor, a position sensor, a speed sensor, an angular velocity sensor, an acceleration sensor, a humidity sensor, and an odor sensor. Power supply controller 1001 does not necessarily include sensor 9.

An operation of power supply controller 1001 will be described below. According to Embodiment 1, starter switch 2 is a reed switch.

Power switch 3 and starter switch 2 can be both switched selectively to a first status and a second status. According to Embodiment 1, power switch 3 and starter switch 2 in the first status correspond to power switch 3 and starter switch 2 that are turned on. Power switch 3 and starter switch 2 in the second status correspond to power switch 3 and starter switch 2 that are turned off. When at least one of power switch 3 and starter switch 2 is in the first status, power supply controlling section 5 supplies power from power supply section 1 to controlling section 4. When both of power switch 3 and starter switch 2 are in the second status, power supply controlling section 5 does not supply power from power supply section 1 to controlling section 4. According to Embodiment 1, when at least one of starter switch 2 and power switch 3 is turned on, power supply controlling section 5 supplies power from power supply section 1 to controlling section 4. When both of starter switch 2 and power switch 3 are turned off, power supply controlling section 5 does not supply power supply from power supply section 1 to controlling section 4. The first status of starter switch 2 corresponds to the status in which power can be supplied from power supply section 1 to controlling section 4. The second status of starter switch 2 corresponds to the status in which no power is supplied from power supply section 1 to controlling section 4.

When both of power switch 3 and starter switch are turned off, that is, are in the second status, a user places a magnet close to starter switch 2 to turn on starter switch 2, that is, the user causes starter switch 2 to be in the first status, and then, power supply controlling section 5 supplies power from power supply section 1 to controlling section 4. Upon receiving the power, controlling section 4 drives display 8 to notify the user that the power is supplied to controlling section 4.

Then, when the magnet placed close to starter switch 2 is removed away from starter switch 2, starter switch 2 is turned off, i.e., in the second status. When starter switch 2 is in the second status and power switch 3 is also turned off, i.e., in the second status, power supply controlling section 5 stops supplying of the power from power supply section 1 to controlling section 4.

However, when controlling section 4 confirms that communication section 6 can communicate with destination device 7 before the user removes away the magnet close to starter switch 2 to cause starter switch 2 to be in the second status, power supply controlling section 5 continues supplying the power from power supply section 1 to controlling section 4 even when starter switch 2 is in the second status. This operation will be detailed below.

When starter switch 2 is turned on, i.e., in the first status, power supply controlling section 5 supplies power from power supply section 1 to controlling section 4. Controlling section 4 causes communication section 6 to wirelessly transmit an existence request signal to destination device 7. The existence request signal is a signal for causing destination device 7 to notify communication section 6 that destination device 7 exists with in an area within which destination device 7 can wirelessly communicate with communication section 6. Upon receiving the existence request signal, destination device 7 sends an existence response signal to communication section 6. The existence response signal is a signal for notifying communication section 6 that destination device 7 exists in the area within which destination device 7 can wirelessly communicate with communication section 6, and thus for notifying communication section 6 that destination device 7 can wirelessly communicate with communication section 6.

When communication section 6 receives the existence response signal from destination device 7, controlling section 4 can confirm that destination device 7 exists in the area within which destination device 7 can wirelessly communicate with communication section 6. When controlling section 4 confirms that communication section 6 can communicate with destination device 7, controlling section 4 controls power switch 3 to continue turning on power switch 3, i.e., being in the first status. Then, even when the user removes the magnet away from starter switch 2 to turn off starter switch 2, i.e., to cause starter switch 6 to be in the second status, power switch 3 which is turned on, i.e., in the first status, allows the power from power supply section 1 to be continuously supplied via power supply controlling section 5 to controlling section 4. The above operation prevents power switch 3 from being turned on so long as communication section 6 can communicate with destination device 7 even when starter switch 2 malfunctions due to vibration to be turned on. When communication section 6 can not communicate with destination device 7, and when the malfunctioning of starter switch 2 is cancelled and starter switch 2 is turned off, no more power is supplied from power supply section 1 to controlling section 4. This operation can consequently prevent the power of power supply section 1 from being consumed for a long time, even when starter switch 2 malfunctions to be turned on.

In power supply controller 1001 according to Embodiment 1, controlling section 4 transmits data detected by sensor 9 from communication section 6 to destination device 7. When communication section 6 can not communicate with destination device 7 and when the data detected by sensor is continuously transmitted to destination device 7 in spite that the data cannot be delivered to destination device 7, the power of power supply section 1 is consumed wastefully. In power supply controller 1001 according to Embodiment 1, when controlling section 4 confirms that the user intentionally turns on starter switch 2, i.e., causes starter switch 2 to be in the first status, and when communication section 6 can communicate with destination device 7, controlling section 4 turns on power switch 3, i.e., causes power switch 3 to be in the first status. If controlling section 4 confirms that the user intentionally turns on starter switch 2, i.e., causes starter switch 3 to be in the first status, but communication section 6 cannot communicate with destination device 7, then controlling section 4 turns off power switch 3, i.e., causes power switch 3 to be in the second status. This operation can consequently prevent the data detected by sensor 9 from being continuously transmitted to destination device 7 in spite that the data cannot be delivered to destination device 7, thus preventing the wasteful consumption of the power of power supply section 1.

Alternatively, controlling section 4 may supply the power from power supply section 1 to sensor 9 only when power switch 3 is turned on, i.e., in the first status. In this case, controlling section 4 does not supply the power from power supply section 1 to, sensor 9 when power switch 3 is turned off, i.e., in the second status. This operation can allow the power to be supplied to sensor 9 only when communication section 6 can communicate with destination device 7, thereby reducing power consumption.

Power supply controller 1001 may include display 8 connected to controlling section 4. Controlling section 4 drives display 8 when the power is supplied to controlling section 4. This operation can consequently avoid wasteful consumption of power to display 8 when power supply controller 1001 is not used. Alternatively, controlling section 4 allows display 8 to display the status of at least one of power switch 3 and starter switch 2. Thus, the user looks at display 8 to confirm whether or not power switch 3 is turned on, i.e., in the first status, thereby confirming whether destination device 7 can communicate with communication section 6 or not. Thus, the user can identify the status of power supply controller 1001.

When communication section 6 completes the transmitting of the data detected by sensor 9 to destination device 7, controlling section 4 may switch the status of power switch 3 to turn off power switch 3 being turned on. Starter switch 2 is turned off when the user does not place the magnet close to starter switch 2. Therefore, power supply controlling section 5 stops the supply of the power from power supply section 1 to controlling section 4. As a result, the power supplied to controlling section 4 can be automatically stopped after the completion of a required operation, thus reducing the power consumption.

Destination device 7 may be connected to network 7A. After the existence response signal is received by communication section 6, controlling section 4 maintains power switch 3 to be turned on. Alternatively, controlling section 4 may turn on power switch 3 not immediately after communication section 6 receives the existence response signal, but instead, may turn on power-switch 3 when communication section 6 further receives a network participation response signal from destination device 7. Specifically, after communication section 6 receives the existence response signal, controlling section 4 causes communication section 6 to transmit a network participation request signal to destination device 7. Upon receiving the network participation request signal, destination device 7 transmits the network participation response signal to communication section 6 when power supply controller 1001 satisfies a condition to participate network 7A. When power supply controller 1001 does not satisfy the condition to participate network 7A, destination device 7 having received the network participation request signal does not transmit the network participation response signal to communication section 6. When communication section 6 receives the network participation response signal from destination device 7, controlling section 4 confirms that the participation in network 7A via destination device 7 is possible, thus maintaining power switch 3 to be turned on. In this manner, power is supplied to controlling section 4 only when communication section 6 and destination device 7 can be connected to network 7A, thus providing improved security.

Alternatively, controlling section 4 does not turn on power switch 3, i.e., causes power switch 3 to be in the first status immediately after receiving the network participation response signal, but instead, controlling section 4 turns on power switch 3, i.e., causes power switch 3 to be in the first status when a link response signal is further received from destination device 7. Specifically, after receiving the network participation response signal, controlling section 4 transmit a link request signal from communication section 6 to destination device 7. Upon receiving the link request signal, destination device 7 transmits a link response signal to communication section 6 when power supply controller 1001 satisfies the link conditions. Upon receiving the link request signal, destination device 7 does not transmit the link response signal to communication section 6 when power supply controller 1001 does not satisfy a link condition. When communication section 6 receives the link response signal from destination device 7, controlling section 4 confirms that the link to destination device 7 is established and maintains power switch 3 to be turned on, i.e., to be in the first status. This operation can consequently allows power to be supplied to controlling section 4 only when the link can be established between communication section 6 and destination device 7, thus providing improved security.

Controlling section 4 may include memory 4A. Controlling section 4 causes the memory to store an operation number, the number of times controlling section 4 is actuated by starter switch 2. Instead of the operation number, controlling section 4 may cause memory 4A to store an accumulated value of a driving time during which power was supplied to controlling section 4 for driving controlling section 4. As a result, controlling section 4 can know the status of power supply controller 1001. This status may be displayed on display 8 to notify the user of the status. If power supply section 1 is a battery, controlling section 4 may calculate the remaining amount of electricity in the battery based on the operation number or the driving time stored in memory 4A to display information indicating the remaining amount of the battery on display 8, thereby notifying the user of the status of the battery status. In addition, the operation number that can secure the normal operation of power supply controller 1001 may be defined as a specified operation number based on the capacity of the battery of power supply section 1. When the operation number stored in memory 4A does not exceed the predetermined number, controlling section 4 maintains power switch 3 to be turned on and operates. When the operation number recorded in memory 4A exceeds the predetermined number, display 8 displays an indication indicating that the operation number exceeds the predetermined number or controlling section 4 stop the operation. Alternatively, based on the capacity of the battery of power supply section 1, the driving time of controlling section 4 that can secure the normal operation of power supply controller 1001 may be defined as a predetermined time. When the driving time stored in memory 4A does not exceed the predetermined time, controlling section 4 maintains power switch 3 to be turned on and operates. When the driving time stored in memory 4A exceeds the predetermined time, display 8 displays the indication that the driving time exceeds the predetermined time or controlling section 4 stops the operation. This operation prevents power supply controller 1001 from operating unstably due to a small amount of electricity charged in the battery.

When controlling section 4 calculates the remaining battery amount based on the operation number or the driving time stored in memory 4A and finds that the remaining battery amount is insufficient for the next operation, controlling section 4 stops the operation of sensor 9. This operation can consequently prevent sensor 9 from operating unstably when the remaining amount of electricity of the battery is insufficient.

Memory 4A may employ a nonvolatile memory. Memory 4A employing the nonvolatile memory can store the information of power supply controller 1001, such as the operation number or the driving time, even when the power is not supplied

According to Embodiment 1, starter switch 2 is a reed switch, but is not limited to this.

In power supply controller 1001 according to Embodiment 1, the first status of power switch 3 and starter switch 2 corresponds to the status in which power switch 3 and starter switch 2 are turned on. The second status of power switch 3 and starter switch 2 corresponds to the status in which power switch 3 and starter switch 2 are turned off. However, these statuses are not limited to them. For example, the first status of power switch 3 may correspond to the status in which power switch 3 is turned off, and the second status may correspond to the status in which the power switch 3 is turned on. The first status of starter switch 2 may correspond to the status in which starter switch 2 is turned off, and the second status may correspond to the status in which starter switch 2 is turned on.

The wording such as “can communicate with” may correspond to the status in which communication section 6 receives the existence response signal from destination device 7, the status in which communication section 6 receives the network participation response signal from destination device 7, or the status in which communication section 6 receives a link response signal from destination device 7, as described above.

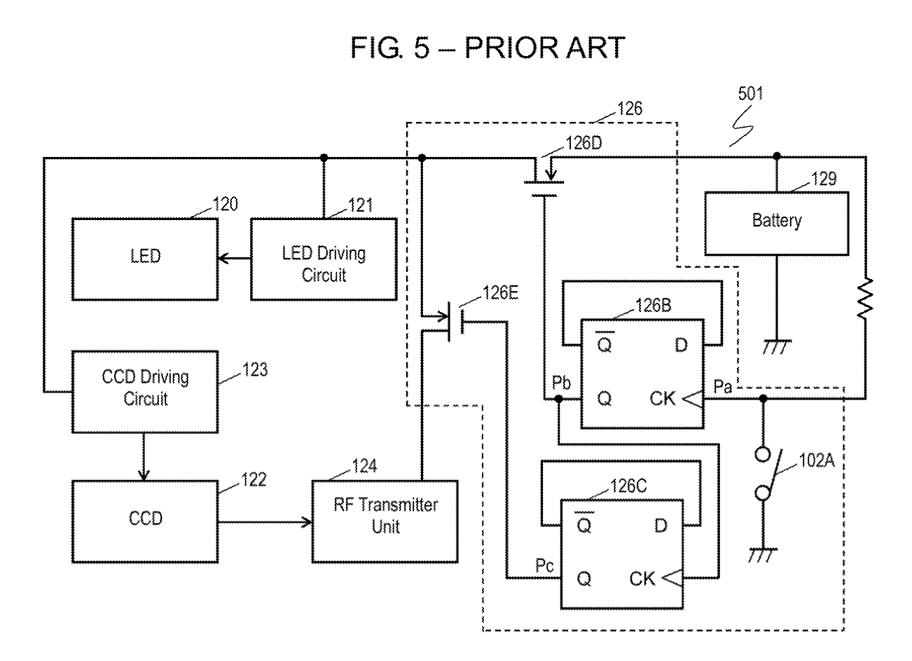

As described above, unlike conventional power supply controller 126 shown in shown in FIG. 5, power supply controller 1001 does not permanently supply power even when starter switch 2 is in the first status. In other words, only after controlling section 4 causes power switch 3 to be in the first status, no power is supplied to controlling section 4 regardless of the status of starter switch 2. This operation can consequently prevent power supply controller 1001 according to Embodiment 1 from continuously operate unexpectedly during transportation due to, e.g. an external impact.

### Exemplary Embodiment 2

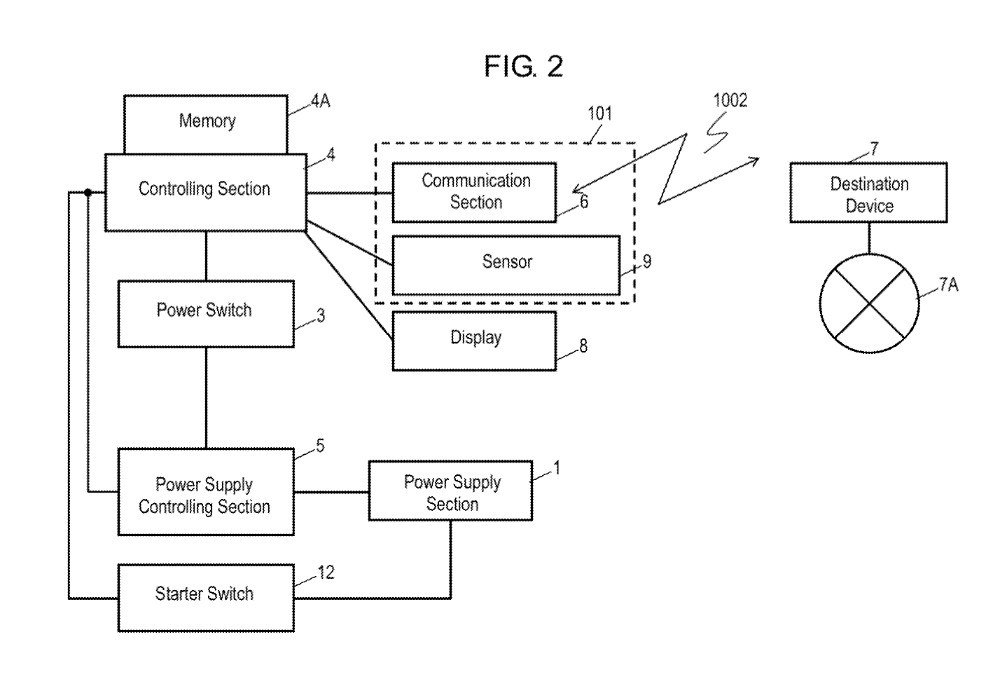

FIG. 2 is a block diagram of power supply controller 1002 according to Exemplary Embodiment 2 of the invention. In FIG. 2, components identical to those of power supply control circuit 1001 according to Embodiment 1 shown in FIG. 1 are denoted by the same reference numerals. Power supply control circuit 1002 shown in FIG. 2 includes starter switch 12 instead of starter switch 2 power supply control circuit 1001 shown in FIG. 1. Power supply controlling section 5 and starter switch 12 are both connected to controlling section 4.

Power supply section 1 supplies driving power to controlling section 4 via power supply controlling section 5 or starter switch 12.

Starter switch 12 functions as a trigger to firstly supply a power from power supply section 1 to controlling section 4. Similarly to starter switch 2 according to Embodiment 1 shown in FIG. 1, starter switch 12 may be, for example, a switch button operated by a user, a reed switch operating within a magnetic field, or a noncontact switch, such as a transistor, or a contact switch, such as a relay, performing a switch operation.

When power switch 3 is turned on, i.e., in the first status, power supply controlling section 5 supplies a power from power supply section 1 to controlling section 4.

An operation of power supply controller 1002 shown in FIG. 2 will be detailed below. According to Embodiment 2, starter switch 12 is a reed switch.

Similarly to power switch 3, starter switch 12 can be switched to the first status and the second status. According to Embodiment 2, starter switch 12 being in the first status corresponds starter switch 12 turned on, and starter switch 12 being in the second status corresponds to starter switch 12 turned off. When the user moves a magnet to be close to starter switch 12, starter switch 12 is turned on, i.e., in the first status, and power is supplied from power supply section 1 via starter switch 12 to controlling section 4. The first status of starter switch 12 corresponds to the status in which a power can be supplied from power supply section 1 to controlling section 4. The second status of starter switch 12 corresponds to the status in which no power is supplied from power supply section 1 to controlling section 4.

Controlling section 4 confirms whether or not communication section 6 can communicate with destination device 7. Similarly to power supply controller 1001 according to Embodiment 1, controlling section 4 controls power switch 3 to cause power switch 3 is in the first status when communication section 6 can communicate with destination device 7.

When power switch 3 is in the first status, i.e., is turned on, power supply controlling section 5 continuously allows power supply section 1 to supply a power via power supply controlling section 5 to controlling section 4. Before starter switch 12 is in the first status, power switch 3 is in the second status and is turned off not in the first status, and thus, no power is supplied from power supply section 1 via power supply controlling section 5 to controlling section 4. Thus, when starter switch 12 is in the second status, i.e., is turned off and power switch 3 is in the second status, i.e., turned off, no power is supplied from power supply section 1 to controlling section 4.

Until starter switch 12 is turned on, no power is consumed by components, such as controlling section 4. Thus, if power supply section 1 is a battery, the reduction of the battery energy can be suppressed even after the storage for a long period of time.

Furthermore, even when starter switch 12 is turned on due to malfunction, no power is supplied to controlling section 4 by cancelling the malfunctioning of starter switch 12, i.e., by causing starter switch 12 to be in the second status, i.e., turned off. This operation can consequently prevent the wasteful power consumption due to the malfunction of starter switch 12.

As described above, power supply controller 1002 according to Embodiment 2 has a configuration not substantially different from that of power supply controller 1001 according to Embodiment 1 except for the position connected to starter switch 12 and also provides the same operation except for the above one, thus providing the same effect as Embodiment 1.

### Exemplary Embodiment 3

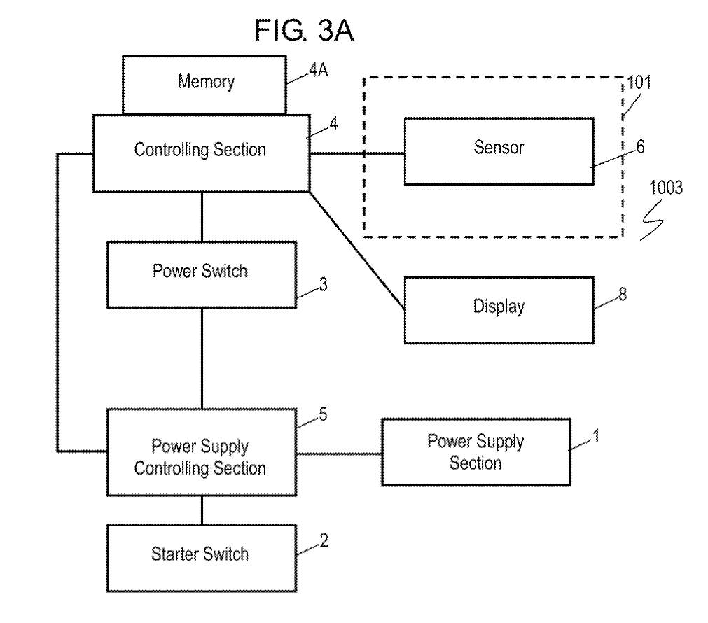

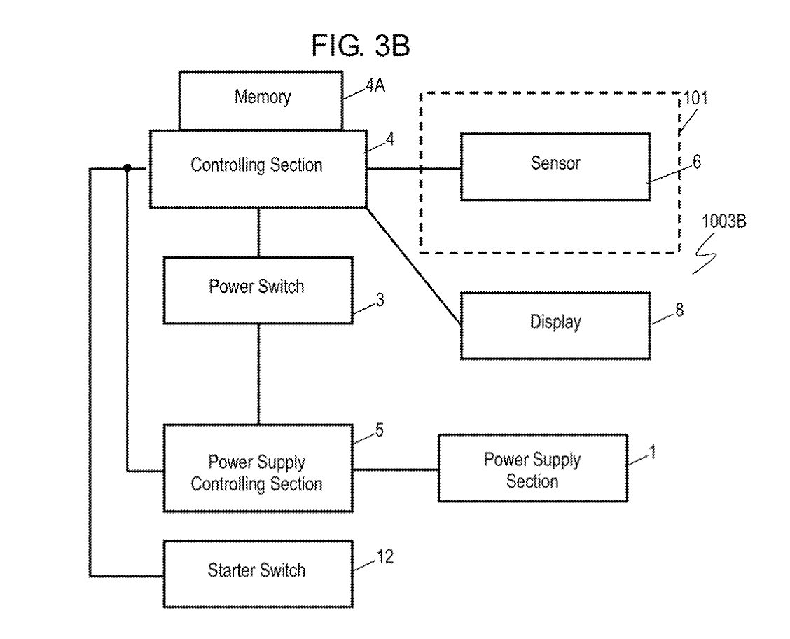

FIG. 3A is a block diagram of power supply controller 1003 according to Exemplary Embodiment 3. In FIG. 3A, components identical to those of power supply control circuit 1003 according to Embodiment 1 shown in FIG. 1 are denoted by the same reference numerals. Power supply controller 1003 according to Embodiment 3 shown in FIG. 3A does not include communication section 6 of power supply controller 1001 according to Embodiment 1 shown in FIG. 1. Specifically, function section 101 does not include communication section 6.

Power supply controller 1003 according to Embodiment 3 is different from power supply controller according to Embodiment 1 in a condition required for controlling section 4 to switch power switch 3 to the first status to maintain power switch 3 to be in the first status.

When a user operation causes starter switch 2 to be in the first status, i.e., to be turned on, power supply controlling section 5 causes the power from power supply section 1 to be supplied to controlling section 4. Upon receiving the power, controlling section 4 may drive display 8 to notify the user that the power is supplied to controlling section 4.

Next, when power switch 3 is in the second status, i.e., is turned off, controlling section 4 drives sensor 9 to change, when data detected by sensor 9 is within a predetermined range, the status of power switch 3 to the first status, i.e., turns on power switch 3 and maintains power switch 3 to be in the first status. When the data detected by sensor 9 is not within the predetermined range, controlling section 4 maintains power switch 3 to be in the second status, i.e., to be turned off. Thus, power switch 3 maintained to be in the first status, i.e., turned on allows power supply controlling section 5 to continuously supply the power from power supply section 1 to controlling section 4 even when the user changes the status of starter switch 2 to the second status, turns off starter switch 2. At this moment, controlling section 4 may allow display 8 to display an indication indicating that power switch 3 is maintained in the first status, i.e., is turned on to notify the user the indication.

As described above, in the power supply controller according to Embodiment 3, based on the condition that the detected result of sensor 9 is within the predetermined range, controlling section 4 to change the status of power switch 3 to the first status to maintain the status of power switch 3 to be in the first status. This operation allows the power supply controller according to Embodiment 3 is triggered by the condition that sensor 9 is placed in an environment suitable for performing a detection operation (i.e., the condition that a small sensor apparatus having the power supply controller according to Embodiment 3 mounted thereto is placed in an environment intended by the user), thereby preventing the wasteful power consumption. This can consequently prevent the power of power supply section 1 from being continuously supplied to controlling section 4 even when starter switch 2 is accidentally and temporarily in the first status during the transportation of the small sensor apparatus having power supply controller according to Embodiment 3 mounted thereto.

Alternatively, upon completion of a processing employing sensor 9, controlling section 4 switches power switch 3 to the second status, i.e., turns off power switch 3 stop the power supplied to controlling section 4. However, when the user intentionally maintains starter switch 2 to be in the first status, controlling section 4 maintains power switch 3 to be in the first status, to be turned on. This operation can consequently prevent the wasteful consumption in, e.g. controlling section 4.

The predetermined range of the data detected by sensor means may be, for example, the temperature range from 0° C. to 40° C. or the temperature ranges out of the temperature range from 0° C. to 40° C. in the case that sensor 9 is a temperature sensor. Thus, the predetermined range is a range of data reasonably expected to detect under a detection environment for the sensor intended by the user. That is, the predetermined range is a range not including data detected when the sensor is placed under an environment not intended by the user.

In power supply controller 1003 shown in FIG. 3A, starter switch 2 is connected to power supply controlling section 5. However, it is not limited to this. FIG. 3B is a block diagram of another power supply controller 1003B according to Embodiment 3. In FIG. 3B, components identical to those of power supply controller 1002 according to Embodiment 2 shown in FIG. 2 are denoted by the same reference numerals. Power supply controller 1003B according to Embodiment 3 shown in FIG. 3B does not include communication section 6 or destination device 7 of power supply controller 1002 according to Embodiment 2 shown in FIG. 2. Starter switch 12 is connected between power supply section 1 and controlling section 4. This configuration can provide the power from power supply section 1 to controlling section 4 bypassing power supply controlling section 5, thus reducing a power supply loss.

Controlling section 4 may include memory 4A. Memory 4A accumulates the data detected by sensor 9. Controlling section 4 can transfer the accumulated data via an interface, such as USB, to an external device. This configuration does not require a communication section in power supply controller 1003 (1003B), hence providing power supply controller 1003 (1003B) with a smaller size. Each of power supply controllers 1003 and 1003B shown in FIGS. 3A and 3B may include a communication section. In this case, as in power supply controllers 1001 and 1002 according to Embodiments 1 and 2, when the data detected by sensor 9 is within the predetermined range and the communication section can communicate with the destination device, controlling section 4 may switch the status of power switch 3 from the second status to the first status. This operation can more securely confirm whether an electronic device having the power supply controller mounted thereto is to be operated or not, thus preventing a wasteful power consumption.

### Exemplary Embodiment 4

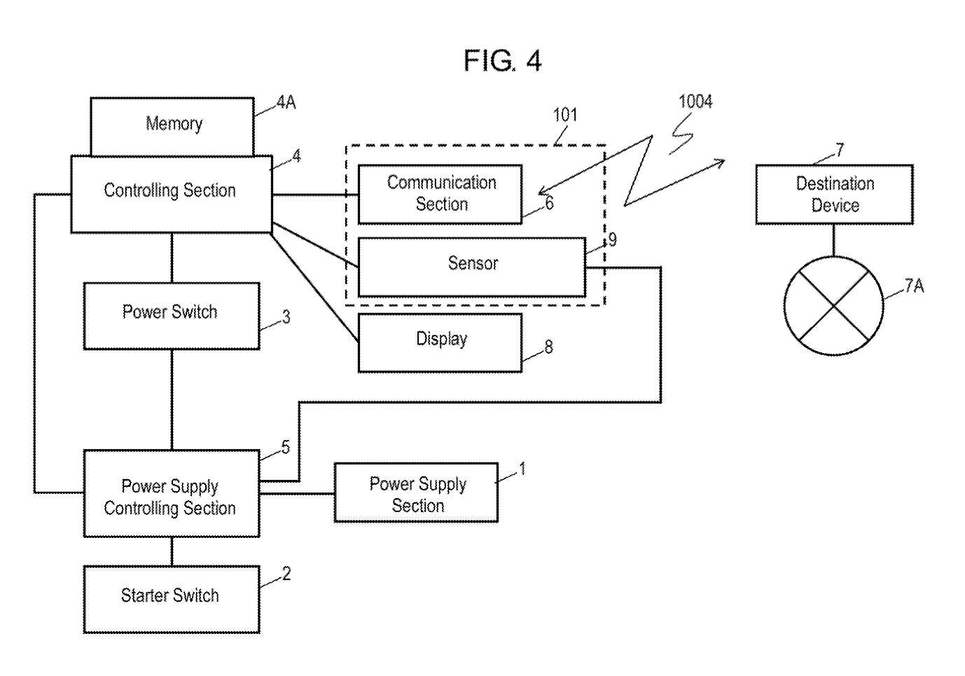

FIG. 4 is a block diagram of power supply controller 1004 according to Embodiment 4. In FIG. 4, components identical to those of power supply control circuit 1001 according to Embodiment 1 shown in FIG. 1 are denoted by the same reference numerals. In the power supply controller according to Embodiment 4, unlike power supply control circuit 1001 according to Embodiment 1 shown in FIG. 1, power is supplied from power supply section 1 via power supply controlling section 5 to sensor 9.

In an initial stage, starter switch 2 and power switch 3 are both in the second status, i.e., turned off, differently from in the first status, i.e., turned on. Thus, no power is supplied from power supply section 1 through power supply controlling section 5 to controlling section 4 at this moment.

Next, when a user's operation, for example, switches starter switch 2 from the second status to the first status, power supply controlling section 5 allows the power from power supply section 1 to be supplied to controlling section 4. Upon receiving the power, controlling section 4 may drive display 8 to notify the user that the power is supplied to controlling section 4.

Next, upon confirming that communication section 6 can communicate with destination device 7, controlling section 4 maintains power switch 3 to be in the first status during a period within which communication section 6 can communicate with destination device 7. This operation consequently allows the power from power supply section 1 to be continuously supplied to controlling section 4 even when the user switches the status of starter switch 2 to the second status.

Next, when power switch 3 is in the first status, power supply controlling section 5 continuously allows the power from power supply section 1 to be supplied to sensor 9. When power switch 3 is in the second status, no power from power supply section 1 is supplied to sensor 9. This operation can consequently prevent the power from being supplied to sensor 9 over an unnecessary period, thus reducing power consumption in the power supply controller.

Controlling section 4 may cause display 8 to notify the user that power switch 3 is in the first status.

Controlling section 4 causes the data detected by sensor 9 to be transmitted from communication section 6 to destination device 7. Upon the data is completed to transmit to destination device 7, controlling section 4 switches the status of power switch 3 to the second status. This operation can consequently prevent wasteful power consumption in power supply controller 1004.

The term “connected” in Embodiments 1 to 4 means an electrical connection, including not only a direct current connection but an electromagnetic connection.

### INDUSTRIAL APPLICABILITY

A power supply controller according to the present invention does not malfunction and prevents a wasteful consumption of a power supply section even when a starter switch malfunctions, thereby avoiding wasteful consumption of battery. The power supply controller according to the present invention is applicable to battery-driven small electronic devices, such as a small temperature sensor apparatus and a biological sensor apparatus.

### REFERENCE MARKS IN THE DRAWINGS

1 Power Supply Section
2 Starter Switch
3 Power Switch
4 Controlling Section
5 Power Supply Controlling Section
6 Communication Section
7 Destination Device
8 Display
9 Sensor

1. A power supply controller comprising:
a power supply section;
a power supply controlling section connected to the power supply section;
a starter switch connected to the power supply controlling section, the starter switch being switched selectively to a first status and a second status;
a power switch connected to the power supply controlling section, the power switch being switched selectively to a first status and a second status;
a controlling section connected to the power switch; and
a function section connected to the controlling section, the function section being operable to execute a predetermined operation,
wherein the power supply controlling section causes a power to be supplied from the power supply section to the controlling section when at least one of the power switch and the starter switch is in the first status.

2. A power supply controller, comprising:
a power supply section;
a power supply controlling section connected to the power supply section;
a power switch connected to the power supply controlling section, the power switch being switched selectively to a first status and a second status;
a controlling section connected to the power switch;
a starter switch connected between the power supply section and the controlling section, the starter switch being switched selectively to a first status and a second status; and
a function section connected to the controlling section, the function section being operable to execute a predetermined operation,
wherein power is supplied from the power supply section to the controlling section when the starter switch is in the first status, and
wherein the power supply controlling section causes power to be supplied from the power supply section to the controlling section if the power switch is in the first status.

3. The power supply controller according to claim 1,
wherein the function section includes a communication section that can communicate with a destination device, and
wherein the controlling section is operable to maintain the power switch to be in the first status when the controlling section receives the power from the power supply section and the communication section can communicate with the destination device.

4. The power supply controller according to claim 3,
wherein the destination device is connected to a network,
wherein the controlling section is operable to maintain the power switch to be in the first status if a participation in the network is requested to the destination device via the communication section and the communication section subsequently receives from the destination device an approval for the participation in the network.

5. The power supply controller according to claim 4, wherein the controlling section is operable to
upon receiving the approval for the participation in the network, transmit a link request via the communication section to the destination device, and
maintain the power switch to be in the first status if the link request is transmitted to the destination device via the communication section and then an approval for a link request approval is received from the destination device.

6. The power supply controller according to claim 1,
wherein the function section includes a sensor for detecting data, and
wherein the controlling section maintains the power switch to be in the first status if the data detected by the sensor is within a predetermined range.

7. The power supply controller according to claim 1, further comprising
a display connected to the controlling section,
wherein the controlling section drives the display if the power is supplied to the controlling section.

8. The power supply controller according to claim 7, wherein the controlling section displays, on the display, a status of at least one of the power switch and the starter switch.

9. The power supply controller according to claim 1,
wherein the function section includes a sensor for detecting data, and
wherein the controlling section causes the power from the power supply section to be supplied to the sensor only when the power switch is in the first status.

10. The power supply controller according to claim 1, wherein the controlling section stores an operation number which is a number of times the controlling section is activated by the starter switch.

11. The power supply controller according to claim 10, further comprising
a display connected to the controlling section,
wherein the display displays an indication indicating that the operation number does not exceed a predetermined number if the operation number does not exceed the predetermined number.

12. The power supply controller according to claim 10, wherein the controlling section does not operate if the operation number does not exceed the predetermined number,

13. The power supply controller according to claim 1, wherein the controlling section stores a driving time during which the controlling section operates.

14. The power supply controller according to claim 13,
wherein the power supply controller further includes a display connected to the controlling section, and
wherein the display displays an indication indicating that the driving time does not exceed a predetermined time if the driving time does not exceed the predetermined time.

15. The power supply controller according to claim 13, wherein the controlling section does not operate if the driving time does not exceed a predetermined time.

16. The power supply controller according to claim 2,
wherein the function section includes a communication section that can communicate with a destination device, and
wherein the controlling section is operable to maintain the power switch to be in the first status when the controlling section receives the power from the power supply section and the communication section can communicate with the destination device.

17. The power supply controller according to claim 2,
wherein the function section includes a sensor for detecting data, and
wherein the controlling section maintains the power switch to be in the first status if the data detected by the sensor is within a predetermined range.

18. The power supply controller according to claim 2, further comprising
a display connected to the controlling section,
wherein the controlling section drives the display if the power is supplied to the controlling section.

19. The power supply controller according to claim 2,
wherein the function section includes a sensor for detecting data, and
wherein the controlling section causes the power from the power supply section to be supplied to the sensor only when the power switch is in the first status.

20. The power supply controller according to claim 2, wherein the controlling section stores an operation number which is a number of times the controlling section is activated by the starter switch.

21. The power supply controller according to claim 2, wherein the controlling section stores a driving time during which the controlling section operates.
